(19) United States
(12) Patent Application Publication
(10) Pub. No.: US 2003/0021251 A1
(43) Pub. Date: Jan. 30, 2003

(54) Self-healing wireless communication systems

(76) Inventors: Ramin Moshiri-Tafreshi, Bonita, CA (US); Ralph A. Gholmieh, San Diego, CA (US)

Correspondence Address: COATS & BENNETT, PLLC, P O BOX 5, RALEIGH, NC, 27602, US

(21) Appl. No.: 09/918,019

(22) Filed: Jul. 30, 2001

(51) Int. Cl. H04Q 7/24

(52) U.S. Cl. 370/338; 455/445

(57) ABSTRACT

Wireless communication systems that are capable of detecting a failure and thereby mitigating or substantially eliminating undesirable consequences associated with such failure are disclosed.

### TECHNICAL FIELD

The present invention relates generally to wireless communication systems, and more specifically to wireless communication systems that are capable of detecting a failure and thereby mitigating or substantially eliminating undesirable consequences associated with such failure.

### BACKGROUND OF THE INVENTION

The wireless communication sector is experiencing an unprecedented growth due to an increased use of electronic devices such as cellular or mobile telephones, personal digital assistants and laptops for sharing voice, data, and video information from any point in the world to any other point in the world. Both the number of people or users wishing to transmit information and the amount and types of information to be transmitted are increasing at exponential rates. This unprecendented growth inherently demands better and more reliable wireless communication systems. One reason is that if a failure occurs within a wireless communication system, many users who would like to use their electronic devices to transmit and receive information via such wireless communication system would be negatively affected because they obviously cannot use their electronic devices. Likewise, wireless communication service providers would also be negatively affected because their revenues directly depend on their customers' access to and usage of their wireless communication systems. Therefore, more reliable and better communication systems would provide users or customers with better services and providers with more revenues.

FIG. 1 and its description below help to illustrate how a failure within a wireless communication system can disrupt wireless communication services to many customers and thus reduce wireless communication service providers' revenues. In FIG. 1, some of the infrastructure equipment associated with a conventional wireless communication system are shown. More specifically, there are four sets of radio base stations (RBS1-RBS9) being coupled to a base station controller or BSC 10 via links A-I. Each link may be a wired connection such as a T1, E1 or broadband link or a wireless link that may also be a broadband link. To establish such wireless link, each radio base station may have a transceiver mounted thereon and the BSC 10 may have a transceiver coupled thereto by a wired connection so that communication signals can be transmitted and received, for example, to and from RBS7 and RBS8 or to and from RBS1 and the BSC 10. Each transceiver may transmit the communication signals to another transceiver at various wavelengths including those within the optical spectrum or at various frequencies including those within the radio frequency spectrum above 890 Megahertz and below 50 Gigahertz. Alternatively, each transceiver may transmit the communication signals to a satellite which in turn transmits the received communication signals to another transceiver at various frequencies including those within the radio frequency spectrum above 890 Megahertz and below 50 Gigahertz. Furthermore, each transceiver may include a laser diode so that the wireless transmission between two transceivers is laser transmission.

In operation, mobile units or electronic devices (not shown) within the wireless communication system transmit communication signals to the BSC 10 which in turn transmits the received communication signals to a mobile switching center (not shown) which in turn transmits the received communication signals to an external communication system (not shown) that may include, for example, a public telephone switching network or an Internet network. The BSC 10 is also responsible for receiving communication signals from the external communication system via the mobile switching center and transmitting such received communication signals to the radio base stations. Depending on the type of information being transmitted, the communication signals may include voice signals, data signals or voice and data signals.

A failure, for example, may occur between RBS4 and RBS5. The failure may be caused by (a) an inoperable transceiver mounted on RBS4 or RBS5, (b) a disconnection in the T1, E1 or broadband link between RBS4 and RBS5 or (c) poor weather conditions that effectively degrade the path quality of the wireless link between RBS4 and RBS5 so that wireless communications between such radio base stations are disrupted. If there is a failure between RBS4 and RBS5 such that the link E is no longer available, users or customers who are in the coverage area provided by RBS5 would no longer be able to request wireless communications between their electronic devices and the BSC 10 through RBS5. In effect, wireless communication service is no longer available. With today's technology, each radio base station can typically support between 60 to 120 simultaneous users per sector at one time. Thus, at a minimum, at least 60 users would be negatively affected for a particular time period when there is a failure. More importantly, the number of negatively affected customers exponentially increases as the time associated with fixing such failure increases. This could greatly reduce the potential revenues that wireless communication service providers could have received from billing their customers for airtime if such customers would have had continuous access to their wireless communication systems. This potential reduction of revenues is more apparent as future technology enables the throughput capacity of each radio base station to be increased.

Accordingly, there is a need to mitigate or substantially eliminate adverse consequences such as loss of wireless communication services and loss of potential revenues associated with wireless communication systems' failures.

### SUMMARY OF THE INVENTION

The present invention is generally directed to wireless communication systems and methods of configuring wireless communication systems.

In one embodiment, a wireless communication system is provided. Such wireless communication system comprises (1) a plurality of radio base stations that are (a) operable to transmit communication signals to mobile units within the wireless communication system and to receive communication signals from the mobile units and (b) linearly coupled and (2) a base station controller that is (a) operable to transmit communication signals between such plurality of radio base stations and an external communication system, (b) coupled to a first radio base station of such plurality of radio base stations to establish a first communication channel and (c) also coupled to a second radio base station of such plurality of radio base stations to establish a second communication channel.

In another embodiment, a method of configuring a wireless communication system is provided. In such method, a plurality of radio base stations operable to transmit communication signals to mobile units within the wireless communication system and to receive communication signals from the mobile units are provided. Such plurality of radio base stations are linearly coupled. In addition, a base station controller operable to transmit communication signals between the radio base stations and an external communication system is also provided. This base station controller is coupled to a first radio base station of such plurality of radio base stations to establish a first communication channel and is also coupled to a second radio base station of such plurality of radio base stations to establish a second communication channel.

### BRIEF DESCRIPTION OF THE DRAWINGS

Other objects and features of the present invention and many of the attendant advantages of the present invention will be readily appreciated and become better understood by reference to the detailed description when considered in connection with the accompanying drawings in which like reference numerals designate like parts throughout the figures thereof and wherein:

FIG. 1 illustrates a conventional configuration of a base station controller being coupled to a plurality of radio base stations.

FIG. 2 illustrates one aspect of the present invention in which a base station controller is coupled to two radio base stations of a plurality of radio base stations that are linearly coupled.

FIG. 3 illustrates another aspect of the present invention in an optical synchronous network (hereinafter “SONET”) is coupled to and between a base station controller and two radio base stations of a plurality of radio base stations that are linearly coupled.

### DETAILED DESCRIPTION OF THE PREFERRED EMBODIMENTS

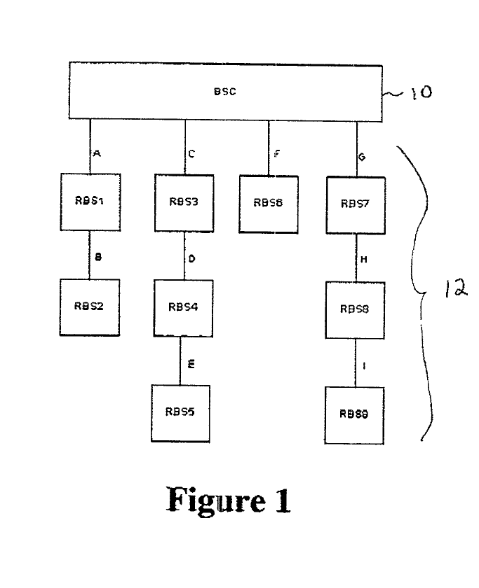

As described above, FIG. 1 illustrates a conventional configuration of a base station controller 10 being coupled to a plurality of radio base stations (RBS1-RBS9). Note that the base station controller 10 is coupled to only one radio base station of a chain of linearly coupled radio base stations. For example, chain 12 includes RBS7-RBS9 that are linearly coupled. Only RBS7 of the chain 12 is coupled to the base station controller 10.

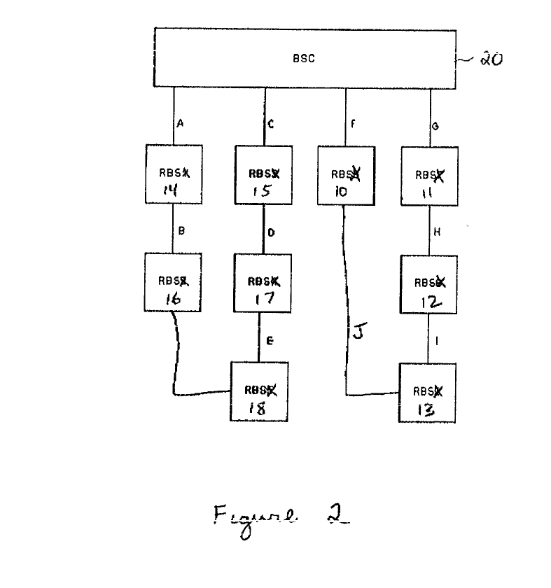

FIG. 2 illustrates some of the infrastructure equipment associated with the present inventive wireless communication system. More specifically, a base station controller 20 is coupled to two radio base stations RBS10 and RBS11 of a plurality of linearly coupled radio base stations RBS10-RBS13 to establish first and second communication channels via links F and G, respectively. Links F and G, for example, may be a wired connection such as a T1, E1 or broadband link or a wireless link that may also be a broadband link. The base station controller 20 uses the first and second communication channels to receive communication signals from RBS10-RBS13 and to transmit communication signals from an external communication system to the RBS10-RBS13. In one preferred embodiment, the base station controller 20 is programmed or configured to use the first communication channel or link F to receive communication signals from RBS10 and to transmit communication signals from the external communication system to the RBS10 and to use the second communication channel or link G to receive communication signals from RBS11-RBS13 and to transmit communication signals from the external communication system to the RBS11-RBS13. More specifically, the base station controller 20 uses link F to receive communication signals from RBS10 and to transmit communication signals from the external communication system to the RBS10 and uses links G, H and I to receive communication signals from RBS11-RBS13 and to transmit communication signals from the external communication system to the RBS11-RBS13. The base station controller 20 does not actively use link J during normal operation. When there is a failure that causes link I to be disrupted or disconnected due to, for example, a loss of signal (LOS), a loss of frame (LOF) or a severely errored second (SES), the base station controller 20 is informed that a failure has been detected. For example, if link I is disconnected so that both upstream and downstream wireless transmissions are no longer available, a network management agent in RBS12 informs the base station controller 20 regarding such failure. If link I is partially disconnected so that only the upstream wireless transmission from RBS13 towards the base station controller 20 is no longer available, RBS12 informs the base station controller 20 regarding such failure by sending an alarm indication signal to the base station controller 20. If link I is partially disconnected so that only the downstream wireless transmission from RBS12 towards RBS13 is no longer available, RBS13 informs the base station controller 20 regarding such failure by sending a remote failure indication to the base station controller 20.

Once the base station controller is informed, the base station controller 20 realizes that it cannot use the second communication channel and links H and I to receive and transmit communication signals to and from RBS13. In response, the base station controller 20 uses the first communication channel and link J to receive and transmit communication signals to and from RBS13. Accordingly, the failure associated with link I does not prevent customers in the coverage area of RBS13 from using their electronic devices for wireless communications. In essence, the customers receive better wireless communication service and the wireless communication service providers collect more revenues because there is no interruption of wireless communication service with respect to RBS13 even though link I is no longer available.

To ensure that the first communication channel or link F is capable of being used to transmit and receive communication signals to and from RBS13 when link I is no longer available, RBS10 should at least have a backhaul capacity to handle wireless communication traffic associated with RBS10 and RBS13. In other words, the backhaul capacity of RBS10 should be enough to support a predetermined percentage of an aggregated air interface capacity that supports wireless communications between RBS10 and RBS13 and electronic devices in the coverage areas of such RBS10 and RBS13. Preferably, the backhaul capacity of RBS10 should be sufficient to handle wireless communication traffic associated with all RBS10-RBS13 so that the first communication link may be used to transmit and receive communication signals to and from (a) RBS10-RBS13 when link G fails, (b) RBS10 and RBS12-RBS13 when link H fails, and (c) RBS10 and RBS13 when link I fails. That is, the backhaul capacity of RBS10 should be enough to support a predetermined percentage of an aggregated air interface capacity that supports wireless communications between RBS10-RBS13 and electronic devices in the coverage areas of such RBS10-RBS13. For both of the above-described embodiments, the predetermined percentage is preferably 30%, more preferably 50% and most preferably 70%.

If link F is no longer available, to ensure that the second communication channel or link G is capable of being used to transmit and receive communication signals to and from RBS10, RBS11 should at least have a backhaul capacity to handle wireless communication traffic associated with RBS10-RBS13. In other words, the backhaul capacity of RBS11 should be enough to support a predetermined percentage of an aggregated air interface capacity that supports wireless communications between RBS10-RBS13 and electronic devices in the coverage areas of such RBS10-RBS13. This predetermined percentage is preferably 30%, more preferably 50% and most preferably 70%. In addition, the backhaul capacity of RBS12 should be sufficient to handle wireless communication traffic associated with RBS10 and RBS12-RBS13. That is, the backhaul capacity of RBS12 should be enough to support a predetermined percentage of an aggregated air interface capacity that supports wireless communications between RBS10 and RBS12-RBS13 and electronic devices in the coverage areas of such RBS10 and RBS12-RBS13. The predetermined percentage associated with the backhaul capacity of RBS12 is preferably 30%, more preferably 50% and most preferably 70%. Furthermore, the backhaul capacity of RBS13 should be sufficient to handle wireless communication traffic associated with RBS10 and RBS13. In other words, the backhaul capacity of RBS13 should be enough to support a predetermined percentage of an aggregated air interface capacity that supports wireless communications between RBS10 and RBS13 and electronic devices in the coverage areas of such RBS10 and RBS13. The predetermined percentage associated with the backhaul capacity of RBS13 is preferably 30%, more preferably 50% and most preferably 70%.

In another preferred embodiment, the base station controller 20 may be configured to use the first communication channel or link F to send and receive communication signals to and from RBS10 and RBS13 and to use the second communication channel or link G to send and receive communication signals to and from RBS11 and RBS12. In this preferred embodiment, the base station controller 20 does not actively use link I during normal operation. If there is a failure associated with link G, the base would use the first communication channel and links I and J to transmit and receive communication signals to and from RBS12 and would use the first communication channel and links H-J to transmit and receive communication signals to and from RBS11. Likewise, if there is a failure associated with link F, the base station controller 20 would use the second communication channel and links G-I to send and receive communication signals to and from RBS13 and would use the second communication channel and links G-J to send and receive communication signals to and from RBS10. In addition, the backhaul capacity of RBS10 should be sufficient to handle wireless communication traffic associated with all RBS10-RBS13, the backhaul capacity of RBS13 should be sufficient to handle wireless communication traffic associated with RBS11-RBS13, the backhaul capacity of RBS12 should be sufficient to handle wireless communication traffic associated with RBS10 and RBS12-RBS13, and the backhaul capacity of RBS11 should be sufficient to handle wireless communication traffic associated with RBS10-RBS13.

To support the potentially large wireless communication traffic associated with the backhaul capacity of RBS10 or RBS11 especially when link F or G fails, the base station controller 20 includes broadband ports (not shown) to accommodate such large traffic. If the link F or G is a wired connection, such wired connection may be directly fastened to one of the broadband ports. If the link F or G is a wireless link, a transceiver that is capable of handling such large traffic may be directly attached to one of the broadband ports.

In addition to the plurality of RBS10-RBS13, the base station controller 20 may also be coupled to another plurality of radio base stations (RBS14-RBS18) that are linearly coupled as shown in FIG. 2. More specifically, the base station controller 20 is coupled to RBS14 and RBS15. The plurality of RBS14-RBS18 may also be coupled to the plurality of RBS10-RBS13 by coupling at least one of RBS14-RBS18 to at least one of RBS10-RBS13 (not shown). This allows the base station controller to use either the first, second, or both the first and second communication channels to transmit and receive communication signals to and from any one of RBS14-RBS18 especially when both of links A and C fail.

It should be noted that the above written description with regard to the backhaul capacity, air interface capacity and predetermined percentage associated with RBS10-RBS13 is also applicable to RBS14-RBS18.

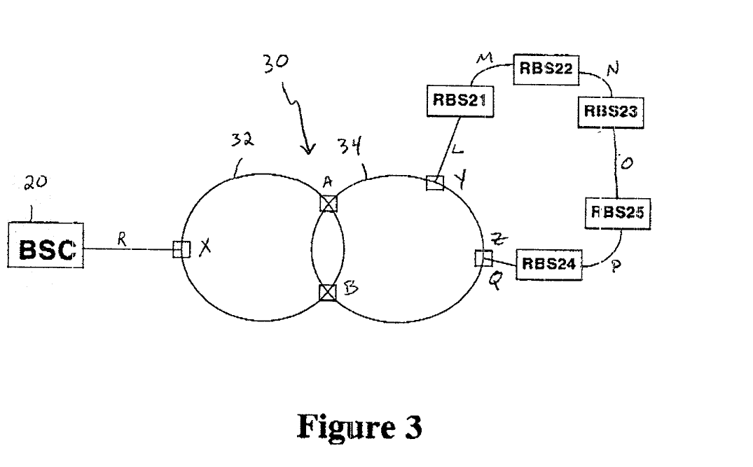

FIG. 3 illustrates another aspect of the present invention in a SONET 30 is coupled to and between a base station controller 20 and two radio base stations (RBS21 and RBS24) of a plurality of radio base stations (RBS21-RBS25) that are linearly coupled. Currently most major cities already have a SONET as part of their infrastructure. Thus, it is desirable to integrate the present invention with such existing infrastructure so as to save costs. In addition, the SONET 30 also has bi-directional rings 32 and 34 that are interconnected at two separate nodes for purposes of redundancy so that if there is a failure at any point on the bi-directional ring 32 or 34, the base station controller 20 would still be able transmit and receive communication signals to and from RBS21-RBS25 via the SONET 30. Instead two bi-directional rings, the SONET 30 may also have only one bi-directional ring or more than two bi-directional rings that are interconnected.

As mentioned above, the SONET 30 is coupled to (1) the base station controller 20 via link R at point of presence X, (2) RBS21 to establish a first communication channel via link L at point of presence Y and (3) RBS24 to establish a second communication channel via link Q at point of presence Z. Links L-R are point-to-point links that may be wired or wireless links. During operation, the base station controller 20 may be configured to use the first communication channel or link L to transmit and receive communication signals to and from RBS21-RBS23 and to use the second communication channel or link Q to transmit and receive communication signals to and from RBS24-RBS25. Thus, the base station controller does not actively use link O for wireless communications during normal operation.

When there is a failure associated with any of the links L-M and P-Q, the base station controller 20 would use the appropriate communication channel and at least link O to transmit and receive communication signals to and from at least one of RBS21-RBS25 that would have been adversely affected by such failure but for link O. For example, if there is a failure associated with link L, RBS21-RBS23 could be affected by such failure because the base station controller could not be able to use the first communication channel to transmit and receive communication signals to and from such RBS21-RBS23. By coupling RBS23 to RBS25 via link O, the base station controller 20 can use the second communication channel or link Q and links M-P to transmit and receive communication signals to and from RBS21-RBS23. Thus, even if there is a failure associated with one of links L-Q, customers would still be able to use their electronic devices because the base station controller 20 would still be able to transmit and receive communication signals to and from any and all of RBS21-RBS25.

It should be noted that the above written description with regard to the backhaul capacity, air interface capacity and predetermined percentage associated with RBS10-RBS13 is also applicable to RBS21-RBS25.

Various embodiments of the present invention described above effectively mitigate or substantially eliminate adverse consequences such as loss of wireless communication services and loss of potential revenues associated with wireless communication systems' failures.

Although particular embodiments of the present invention have been shown and described herein, it will be understood that it is not intended to limit the invention to the preferred embodiments and it will be obvious to those skilled in the art that various changes and modifications may be made without departing from the spirit and scope of the present invention. For example, RBS10 maybe also coupled to one of RBS11-RBS13. Thus, the invention is intended to cover alternatives, modifications, and equivalents, which may be included within the spirit and scope of the invention as defined by the claims.

What is claimed is:

1. A wireless communication system comprising:
a plurality of radio base stations operable to transmit communication signals to mobile units within the wireless communication system and to receive communication signals from the mobile units, wherein the radio base stations are linearly coupled; and
a base station controller operable to transmit communication signals between said plurality of radio base stations and an external communication system, wherein the base station controller is coupled to a first radio base station of said plurality of radio base stations to establish a first communication channel, and further wherein the base station controller is coupled to a second radio base station of said plurality of radio base stations to establish a second communication channel.

2. The wireless communication system of claim 1, wherein at least one of said plurality of radio base stations is coupled to and between the first and second radio base stations.

3. The wireless communication system of claim 1, wherein the base station controller is coupled to the first and second radio base stations via a wired or wireless communication network.

4. The wireless communication system of claim 3, wherein the wired communication network is a SONET.

5. The wireless communication system of claim 4, wherein the SONET comprises at least one bi-directional ring.

6. The wireless communication system of claim 5, wherein said at least one bi-directional ring includes a plurality of bi-directional rings that are interconnected.

7. The wireless communication system of claim 1 further comprising a mobile switching center coupled to the base station controller, said mobile switching being operable to transmit communication signals between the external communication system and the base station controller.

8. The wireless communication system of claim 1, wherein the base station controller uses the second communication channel to receive communication signals from at least one radio base station of said plurality of radio base stations and to transmit communication signals received from the external communication system to said at least one radio base station.

9. The wireless communication system of claim 8, wherein the base station controller uses the first communication channel to receive communication signals from said at least one radio base station and to transmit communication signals received from the external communication system to said at least one radio base station when the base station controller detects that there is a failure associated with the second communication channel.

10. The wireless communication system of claim 8, wherein the base station controller uses the first communication channel to receive communication signals from the first radio base station and to transmit communication signals received from the external communication system to the first radio base station.

11. The wireless communication system of claim 10, wherein the base station controller uses the first communication channel to receive communication signals from said at least one radio base station and to transmit communication signals received from the external communication system to said at least one radio base station when the base station controller detects that there is a failure associated with the second communication channel.

12. The wireless communication system of claim 11, wherein the first radio base station and said at least one radio base station have an air interface capacity to support wireless communications between the first radio base station and said at least one radio base station and the mobile units, and further wherein each of the first radio base station and said at least one radio base station has a backhaul capacity to support a percentage of the air interface capacity.

13. The wireless communication system of claim 1, wherein said plurality of radio base stations have an air interface capacity to support wireless communications between the mobile units and said plurality of radio base stations, and further wherein each of said plurality of radio base stations has a backhaul capacity to support a percentage of the air interface capacity.

14. The wireless communication system of claim 13, wherein the percentage is between 30% and 100%.

15. The wireless communication system of claim 1, wherein communication signals include voice signals, data signals or voice and data signals.

16. A wireless communication system comprising:
a first radio base station operable to transmit communication signals to mobile units within the wireless communication system and to receive communication signals from the mobile units;
a plurality of radio base stations operable to transmit communication signals to mobile units within the wireless communication system and to receive communication signals from the mobile units, wherein said plurality of radio base stations are linearly coupled; and
a base station controller operable to transmit communication signals between the first radio base station and said plurality of radio base stations and an external communication system, wherein the base station controller is coupled to the first radio base station to establish a first communication channel and to a second radio base station of said plurality of radio base stations to establish a second communication channel, and further wherein the first radio base station is coupled to a third radio base station of said plurality of radio base stations.

17. The wireless communication system of claim 16, wherein at least one of said plurality of radio base stations is coupled to and between the first and second radio base stations.

18. The wireless communication system of claim 16 further comprising at least one radio base station coupled to and between the first and third radio base stations.

19. The wireless communication system of claim 16 further comprising at least one radio base station coupled to and between the second and third radio base stations.

20. The wireless communication system of claim 16, wherein the second radio base station and the third radio base station are the same radio base station.

21. The wireless communication system of claim 16, wherein the base station controller is coupled to the first and second radio base stations via a wired or wireless communication network.

22. The wireless communication system of claim 21, wherein the wired communication network is a SONET.

23. The wireless communication system of claim 22, wherein the SONET comprises at least one bi-directional ring.

24. The wireless communication system of claim 23, wherein said at least one bi-directional ring includes a plurality of bi-directional rings that are interconnected.

25. The wireless communication system of claim 16 further comprising a mobile switching center coupled to the base station controller, said mobile switching being operable to transmit communication signals between the external communication system and the base station controller.

26. The wireless communication system of claim 16, wherein the base station controller uses the second communication channel to receive communication signals from the second and third radio base stations and to transmit communication signals received from the external communication system to the second and third radio base stations.

27. The wireless communication system of claim 26, wherein the base station controller uses the first communication channel to receive communication signals from the second and third radio base stations and to transmit communication signals received from the external communication system to the second and third radio base stations when the base station controller detects that there is a failure associated with the second communication channel.

28. The wireless communication system of claim 26, wherein the base station controller uses the first communication channel to receive communication signals from the first radio base station and to transmit communication signals received from the external communication system to the first radio base station.

29. The wireless communication system of claim 28, wherein the base station controller uses the first communication channel to receive communication signals from the second and third radio base stations and transmits communication signals received from the external communication system to the second and third radio base stations when the base station controller detects that there is a failure associated with the second communication channel.

30. The wireless communication system of claim 29, wherein the first, second and third radio base stations have an air interface capacity to support wireless communications between the mobile units and the first, second and third radio base stations, and further wherein each of the first, second and third radio base stations has a backhaul capacity to support a percentage of the air interface capacity.

31. The wireless communication system of claim 14, wherein the first radio base station and said plurality of radio base stations have an air interface capacity to support wireless communications between the mobile units and the first radio base station and said plurality of radio base stations, and further wherein each of the first radio base station and said at least one radio base station has a backhaul capacity to support a percentage of the air interface capacity.

32. The wireless communication system of claim 31, wherein the percentage is between 30% and 100%.

33. The wireless communication system of claim 14, wherein communication signals include voice signals, data signals or voice and data signals.

34. A method of configuring a wireless communication system comprising:
providing a plurality of radio base stations operable to transmit communication signals to mobile units within the wireless communication system and to receive communication signals from the mobile units;
linearly coupling said plurality of radio base stations;
providing a base station controller operable to transmit communication signals between the radio base stations and an external communication system;
coupling the base station controller to a first radio base station of said plurality of radio base stations to establish a first communication channel; and
coupling the base station controller to a second radio base station of said plurality of radio base stations to establish a second communication channel.

35. The method of claim 34 further comprising coupling at least one of said plurality of radio base stations to and between the first and second radio base stations.

36. The method of claim 34 further comprising coupling a wired or wireless communication network to and between the base station controller and the first and second radio base stations.

37. The method of claim 36, wherein the wired communication network is a SONET.

38. The method of claim 34 further comprising:
providing a mobile switching center operable to transmit communication signals between the external communication system and the base station controller; and
coupling the mobile switching center to the base station controller.

39. The method of claim 34 further comprising using the second communication channel to receive communication signals from at least one radio base station of said plurality of radio base stations and to transmit communication signals received from the external communication system to said at least one radio base station.

40. The method of claim 39 further comprising using the first communication channel to receive communication signals from said at least one radio base station and to transmit communication signals received from the external communication system to said at least one radio base station when the base station controller detects that there is a failure associated with the first communication channel.

41. The method of claim 39 further comprising using the first communication channel to receive communication signals from the first radio base station and to transmit communication signals received from the external communication system to the first radio base station.

42. The method of claim 41 further comprising using the first communication channel to receive communication signals from said at least one radio base station and to transmit communication signals received from the external communication system to said at least one radio base station via the second communication channel when the base station controller detects that there is a failure associated with the first communication channel.

43. The method of claim 42, wherein the first radio base station and said at least one radio base station have an air interface capacity to support wireless communications between the first radio base station and said at least one radio base station and the mobile units, and further wherein each of the first radio base station and said at least one radio base station has a backhaul capacity to support a percentage of the air interface capacity.

44. The method of claim 34, wherein said plurality of radio base stations have an air interface capacity to support wireless communications between the mobile units and said plurality of radio base stations, and further wherein each of said plurality of radio base stations has a backhaul capacity to support a percentage of the air interface capacity.

45. The method of claim 44, wherein the percentage is between 30% and 100%.

46. The method of claim 34, wherein communication signals include voice signals, data signals or voice and data signals.
